(19) United States
(12) Patent Application Publication
(10) Pub. No.: US 2017/0010464 A1
(43) Pub. Date: Jan. 12, 2017

(54) Automotive Head-Up Display

(71) Applicant: Xin Rui Fong Inc. Co., Ltd., Taipei City (TW)

(72) Inventor: Yunn Ruey Perng, Taipei City (TW)

(21) Appl. No.: 15/201,702

(22) Filed: Jul. 5, 2016

(30) Foreign Application Priority Data
Jul. 7, 2015 (TW) 104210986

(51) Int. Cl. G02B 27/01; G09G 5/00

(52) U.S. Cl. CPC G02B 27/0149; G09G 5/006; G02B 27/0101; G02B 2027/0159; G02B 2027/0152; G02B 2027/0138; G02B 2027/0161

(57) ABSTRACT

An automotive head-up display includes a first body, a joint element, and a second body. The first body includes a data accessing unit and a processor. The data accessing unit is electrically connected to the engine control unit of a vehicle and obtains at least one driving information of the vehicle. The processor receives the driving information from the data accessing unit and transforms the driving information into a display signal. The second body is connected to the first body via the joint element. The second body includes a displayer and translucent reflector. The displayer receives the display signal by the processor and transforms the display signal to an output screen. The edge of the translucent reflector is connected to the second body, and the translucent reflector reflects the output screen.

### BACKGROUND OF THE INVENTION

1. Field of the Invention

The invention relates to an automotive head-up display, and more particularly relates to an automotive head-up display which is thin and keeping away from the heat source.

2. Description of the Prior Art

Sight is very important for a driver. Driver can clearly note the traffic via a spacious and clear sight so as to safely drive. Sometimes, the driver need to bow to read the information of the vehicle on the dashboard and the information of the vehicle is such as the speed, the fuel amount, the tank temperature, gears or GPS, etc. However, the driver cannot simultaneously note other vehicles in front when the driver bows to read the dashboard, and thus the driver has an accident easily.

Therefore, a head-up display is provided. The head-up display projects the vehicle information to a translucent display board. In other word, the vehicle information is projected in the sight of driver, so the driver does not need to bow to read the dashboard, so as to reduce the possibility of accident. However, the common head-up display has some disadvantages. Please refer to FIG. 1, FIG. 1 shows a conventional head-up display. The main element (ex. CPU) of head-up display 2 is disposed in the body 210, and the display screen is disposed on the top of body 210. In other words, the head-up display 2 is an all-in-one design, thus increasing the thickness the mounting difficulties of the head-up display 2. Furthermore, the display screen 220 produces a lot of heat and the heat directly affects the main element of the body 210. If the main elements are affected by the heat for a long time, the main elements would be malfunctioned so as to decrease the life of the head-up display 2.

Therefore, how to improve the head-up display 2 for reducing the thickness and avoiding overheat is worth considering to a person having ordinary skills in the art.

### SUMMARY OF THE INVENTION

An automotive head-up display is provided in the present invention. The automotive head-up display has thin thickness and keeps away from a heat source.

One object of the present invention is to provide an automotive head-up display. The automotive head-up display is configured to be electrically connected to an engine control unit of a vehicle and includes a first body, a joint element, and a second body. The first body includes a data accessing unit and a processor. The data accessing unit is electrically connected to the engine control unit and obtains driving information of the vehicle. The processor receives the driving information from the data accessing unit and transforms the driving information into a display signal. The second body is connected to the first body via the joint element. The second body includes a displayer and translucent reflector. The displayer receives the display signal by the processor and transforms the display signal to an output screen. The edge of the translucent reflector is connected to the second body, and the translucent reflector reflects the output screen. The translucent reflector is rotated around a junction axis between the translucent reflector and the second body.

One object of the present invention is to provide another automotive head-up display. The automotive head-up display is configured to be electrically connected to an engine control unit of a vehicle and includes a first body, a joint element, and a second body. The first body includes a data accessing unit, a processor, and a translucent reflector. The data accessing unit is electrically connected to the engine control unit and obtains driving information of the vehicle. The processor receives the driving information from the data accessing unit and transforms the driving information into a display signal. The edge of the translucent reflector is connected to the first body. The translucent reflector is rotated around a junction axis between the translucent reflector and the first body. The second body is connected to the first body via the joint element. The second body includes a displayer. The displayer receives the display signal by the processor and transforms the displaying signal to an output screen. In addition, the translucent reflector reflects the output screen.

In above automotive head-up display, the first body further comprises an image pickup unit.

In above automotive head-up display, the first body further comprises a sucking device.

In above automotive head-up display, the second body further comprises a holder.

In above automotive head-up display, wherein, the second body further comprises a light-sheltering structure and the light-sheltering structure is disposed on the edge of the second body.

In above automotive head-up display, the first body further comprises a wireless communication unit communicatively connected to an external electronic device.

In above automotive head-up display, the translucent reflector is detachable.

In above automotive head-up display, the first body further comprises at least one sticking element.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 shows a conventional head-up display.

FIG. 2A shows a block-diagram of an automotive head-up display of an embodiment in the present invention. FIG. 2B shows a diagram of the automotive head-up display of the embodiment.

FIG. 2B shows a diagram of the automotive head-up display of the embodiment.

FIG. 3 shows a diagram of the first body.

FIG. 4 shows the diagram of the second body.

FIG. 5 shows a diagram of the automotive head-up display of another embodiment.

### DESCRIPTION OF THE PREFERRED EMBODIMENTS

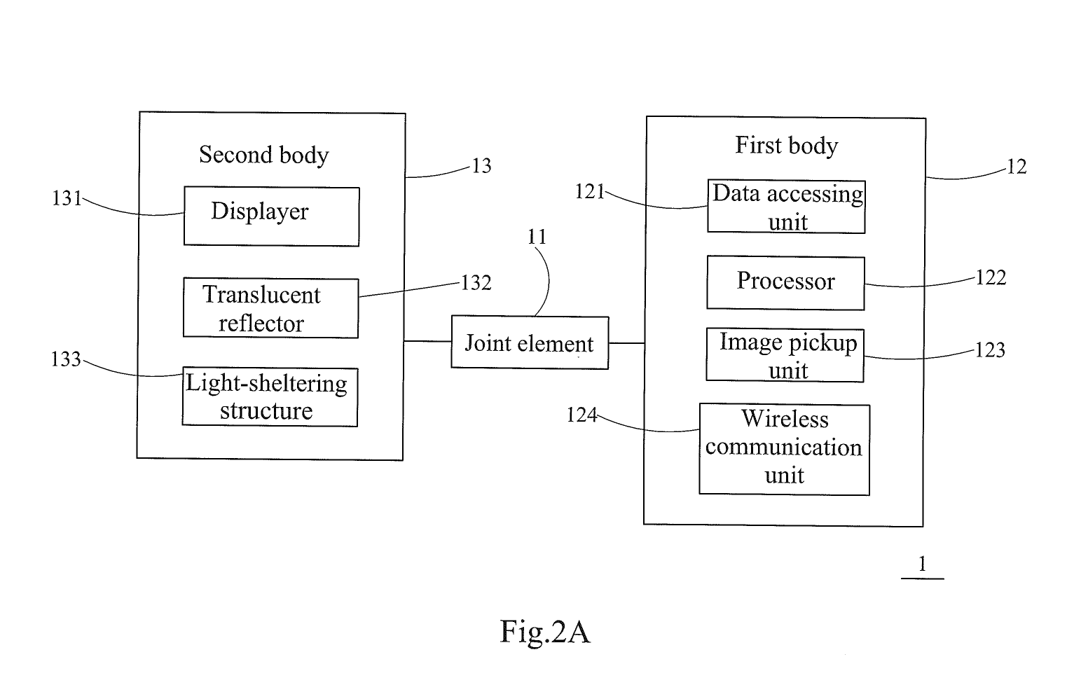

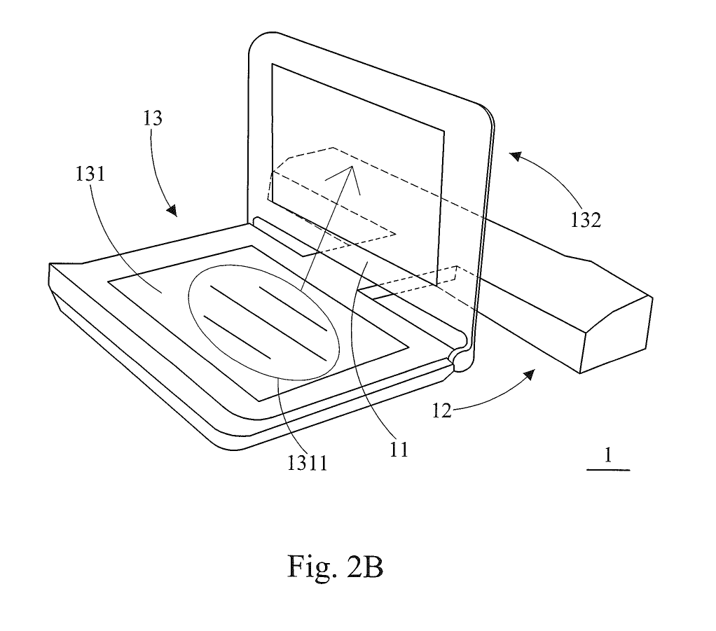

Please refer to FIG. 2A and FIG. 2B. FIG. 2A shows a block-diagram of an automotive head-up display of an embodiment in the present invention. FIG. 2B shows a diagram of the automotive head-up display of the embodiment. An automotive head-up display 1 is provided in the present invention. The automotive head-up display 1 is connected to the engine control unit of a vehicle. The automotive head-up display 1 includes a first body 12, a joint element 11 and a second body 13. The first body 12 includes a data accessing unit 121 and a processor 122. The data accessing unit 121 is electrically connected to the engine control unit and obtains driving information of the vehicle. In the embodiment, the driving information is such as the speed, the fuel amount, the engine speed and the tank temperature, etc. The processor 122 receives the driving information from the data accessing unit 121 and transforms the driving information into a display signal. The first body 12 is connected to second body 13 via the joint element 11. The joint element 11 is stationary or detachable. In other word, the joint element 11 allows the first body 12 and the second body 13 to move or rotate relative to each other. The second body 13 includes a displayer 131 and a translucent reflector 132. The displayer 131 receives the display signal from the processor 122 and transforms the display signal to an output screen 1311. The edge of translucent reflector 132 is connected to the second body 13. The translucent reflector 132 is rotated around a junction axis between the translucent reflector 132 and the second body 13. The translucent reflector 132 looks like a translucent board and is used to reflect the image of the displayer 131. Thus, the translucent reflector 132 is configured to reflect and show the output screen 1311 on the translucent reflector 132. The reflectivity of above-said displayer 131 is 0%-100% and the reflectivity of the translucent reflector 132 is 40%-60%. However, the translucent reflector 132 of the present invention is not limited to above-said one. In the embodiment, the reflectivity of the translucent reflector 132 exceeds 50%.

Furthermore, the translucent reflector 132 is coated with special coating, so that the translucent reflector 132 can reflect the light with different color, i.e. the translucent reflector 132 can reflect the image with different color. Therefore, the data accessing unit 121 and the processor 122 of the first body 12 receives the driving information from the engine control unit, and the driving information would be transmitted to the displayer 131 of the second body 13 and projected on the translucent reflector 132. Thus, the driving information is shown on the translucent reflector 132, so that the driver does not need to bow to read the driving information. Therefore, the safety of the driving is significantly increased.

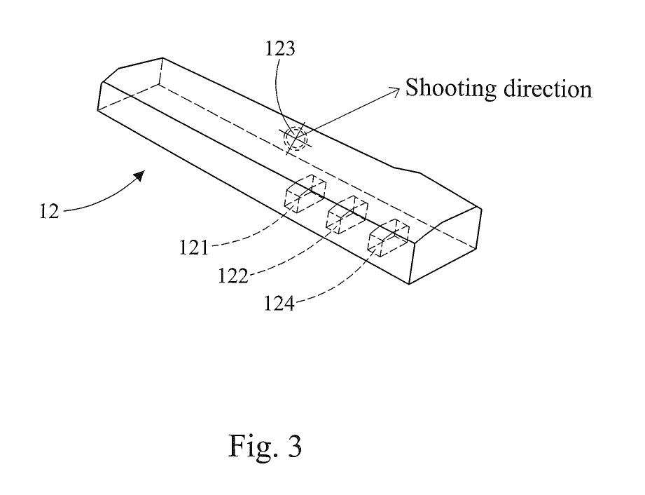

Please refer to FIG. 3. FIG. 3 shows a diagram of the first body. The first body 12 further includes a sucking device, an image pickup unit 123 and a wireless communication unit 124. The sucking device is configured to suck an object so as to make the first body 12 fixed to the object and avoid the first body 12 from dropping. In the embodiment, the sucking device is a sucking disc. However, the person having ordinary skill in the art would understand that the sucking device can be replaced with a sticking element like a double-sided tape or viscous materials. Thus, the automotive head-up display 1 can be fixed to the windshield and other suitable places in the vehicle via the sucking device or the sticking element.

In addition, the image pickup unit 123 is disposed on the first body 12. In the embodiment, the image pickup unit 123 is an embedded lens. The image pickup unit 123 is configured to shoot the object. Particularly, the shooting direction of the image pickup unit 123 and the reflection direction of the translucent reflector 132 are opposite to each other. Therefore, the image pickup unit 123 is used to film the motion of scenery and record the image thereof in driving. In other word, the image pickup unit 123 is regarded as a drive recorder. The above-said image pickup unit 123 is disposed on but not limited to the middle of the first boy 12, but the person having ordinary skill in the art can change the location of the above image pickup unit 123. For example, the image pickup unit 123 can be selectively disposed on the left side or the right side of the first body 12.

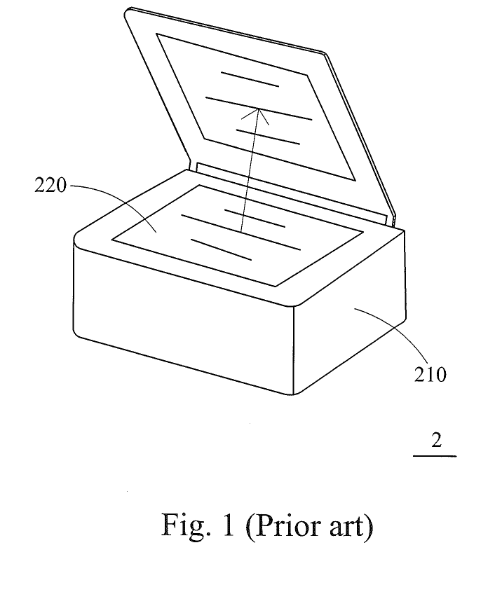

The wireless communication unit 124 is disposed inside the first body 12, and the wireless communication unit 124 is connected to an external electronic device. The wireless communication unit 124 is wireless transmitted with the external electronic device, so that the driving information can be transmitted between the first body 12 and the external electronic device. In the embodiment, the wireless communication way is Wi-Fi and the external electronic device is a smart phone. Therefore, the wireless communication unit 124 can transmit the driving information to the automotive head-up display 1 from the external electronic device, and by this the driver can read the driving information via the automotive head-up display 1. Furthermore, the automotive head-up display 1 is detachable from the first body 12 and the second body 13. The heat of the second body 13 is hard to transmit to the first body 12 so as to avoid the elements of the first body 12 from being damaged and increase the service life of the automotive head-up display 1. In addition, the automotive head-up display 1 is designed as two bodies combined (ex. one of the present invention) and instead of all-in-one design (shown as the prior art in FIG. 1). Thus, the automotive head-up display 1 is designed as two thinner bodies (the first body 12 and second body 13) combined, so that the placement thereof would not be limited due to its thickness.

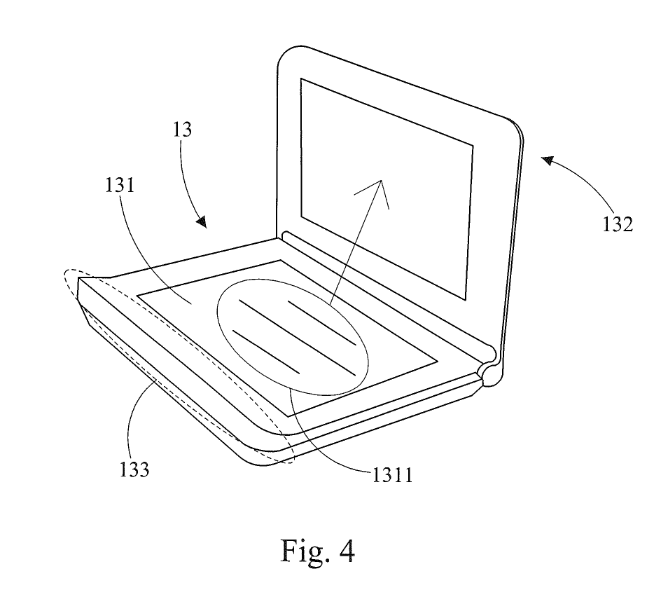

Please refer to FIG. 4. FIG. 4 shows the diagram of the second body. The second body 13 further includes at least one holder and a light-sheltering structure 133. The holder is disposed on the bottom of the second body 13 (not shown). The second body 13 is fixed to the object via the holder so as to avoid the second body 13 from dropping or sliding. The light-sheltering structure 133 is disposed on the edge of the second body 13. The light-sheltering structure 133 is an outward protrusion. With respect to the location of the translucent reflector 132, the light-sheltering structure 133 is disposed on the farthest location. The outward protrusion of light-sheltering structure 133 is configured to shelter the light directly projected from the displayer 131 to the driver. Thus, when the driver is driving, the driver would not be interfered by the light directly projected from the displayer 131.

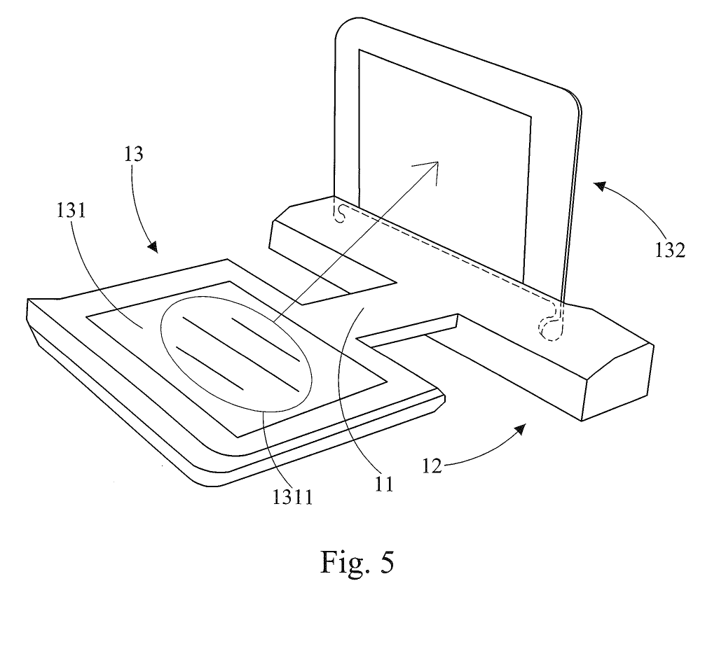

Please refer to FIG. 5. FIG. 5 shows a diagram of the automotive head-up display of another embodiment. The main difference between the above-said embodiment and the embodiment in FIG. 5 is that the translucent reflector 132 in the embodiment is disposed on the first body 12 instead of the second body 13. In other words, the translucent reflector 132 is not limited to dispose on the second body 13. The translucent reflector 132 is selectively disposed on the first body 12 to reflect the light from the displayer 131 of the second body 13 and show the output screen. Therefore, the person having ordinary skill in the art can dispose the translucent reflector 132 on the first body 12 to achieve reflecting and showing the output screen 1311 on the translucent reflector 132. Therefore, disposing the translucent reflector 132 on the first body 12 can also achieve the function of reflecting the output screen 1311, so the user has more choices in selecting the location of the translucent reflector 132.

Furthermore, the translucent reflector 132 is detachable from the first body 12 or the second body 13, and the translucent reflector 132 can be designed like a membrane and directly pasted on the windshield to reflect the driving information. Thus, when the driver is driving, the driver can directly read the driving information on the windshield.

In summary, the automotive head-up display 1 is provided in the present invention. Compared with the head-up display in prior art, the automotive head-up display 1 has thinner thickness and keeps away from the heat source so as to effectively increase the service life of the automotive head-up display 1. Furthermore, the translucent reflector 132 is not limited to dispose on the second body 13. Thus, the user has more choice in selecting the placement of the translucent reflector 132 to satisfy the user's different requirements.

While the preferred embodiment of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. An automotive head-up display configured to be electrically connected to an engine control unit of a vehicle and comprising:
a first body comprising:
a data accessing unit configured to be electrically connected to the engine control unit and obtaining at least one driving information of the vehicle; and
a processor receiving the driving information from the data accessing unit and transforming the driving information into a display signal;
a joint element;
a second body connecting to the first body via the joint element and comprising:
a displayer receiving the display signal from the processor and
transforming the display signal to an output screen; and
a translucent reflector reflecting the output screen;
wherein the edge of the translucent reflector is connected to the second body, and the translucent reflector is rotated around a junction axis between the translucent reflector and the second body.

2. The automotive head-up display of claim 1, wherein the first body further comprises an image pickup unit.

3. The automotive head-up display of claim 1, wherein the first body further comprises a sucking device.

4. The automotive head-up display of claim 1, wherein the second body further comprises a holder.

5. The automotive head-up display of claim 1, wherein the second body further comprises a light-sheltering structure and the light-sheltering is disposed on the edge of the second body.

6. The automotive head-up display of claim 1, wherein the first body further comprises a wireless communication unit communicatively connected to an external electronic device.

7. The automotive head-up display of claim 1, wherein the translucent reflector is detachable.

8. The automotive head-up display of claim 1, wherein the first body further comprises at least one sticking element.

9. An automotive head-up display configured to be electrically connected to an engine control unit of a vehicle and comprising:
a first body comprising:
a data accessing unit configured to be electrically connected to the engine control unit of and obtaining at least one driving information of the vehicle;
a processor receiving the driving information from the data accessing unit and transforming the driving information into a display signal; and
a translucent reflector, the edge of the translucent reflector connected to the first body; the translucent reflector rotating around a junction axis between the translucent reflector and the first body;
a joint element;
a second body connecting to the first body via the joint element and comprising:
a displayer receiving the display signal from the processor and
displaying the display signal on an output screen;
wherein the translucent reflector reflects the output screen.

10. The automotive head-up display of claim 9, wherein the first body further comprises an image pickup.

11. The automotive head-up display of claim 9, wherein the first body further comprises a sucking device.

12. The automotive head-up display of claim 9, wherein the second body further comprises a holder.

13. The automotive head-up display of claim 9, wherein the second body further comprises a light-sheltering structure and the light-sheltering is disposed on the edge of the second body.

14. The automotive head-up display of claim 9, wherein the first body further comprises a wireless communication unit communicatively connected to an external electronic device.

15. The automotive head-up display of claim 9, wherein the translucent reflector is detachable.

16. The automotive head-up display of claim 9, wherein, the first body further comprises at least one sticking element.
